(19) United States
(12) Patent Application Publication
(10) Pub. No.: US 2026/0141555 A1
(43) Pub. Date: May 21, 2026

(54) APPARATUS AND METHOD FOR ESTIMATING THREE-DIMENSIONAL HUMAN POSE

(71) Applicant: CHUNG ANG UNIVERSITY INDUSTRY ACADEMIC COOPERATION FOUNDATION, Seoul (KR)

(72) Inventors: JONG WON CHOI, Gyeongsangnam-do (KR); MIN JI KWAK, Seoul (KR); SU YEON CHA, Seoul (KR); HYUN JIN CHO, Incheon (KR)

(21) Appl. No.: 19/393,927

(22) Filed: Nov. 19, 2025

(30) Foreign Application Priority Data
Nov. 21, 2024 (KR) 10-2024-0167798

(51) Int. Cl. G06T 7/73

(52) U.S. Cl. CPC G06T 7/73; G06T 2207/20081; G06T 2207/20084; G06T 2207/30196

(57) ABSTRACT

An apparatus for estimating the three-dimensional human pose according an embodiment includes a two-dimensional pose estimator configured to generate two-dimensional pose information about joint positions of a human body from an input two-dimensional image, and a lifting network configured to convert the two-dimensional pose information into three-dimensional pose information. A method of estimating a three-dimensional human pose performed on a computing device includes generating two-dimensional pose information about joint positions of a human body from an input two-dimensional image, and converting the two-dimensional pose information into three-dimensional pose information using a lifting network.

### CROSS-REFERENCE TO RELATED APPLICATION AND CLAIM OF PRIORITY

This application claims the benefit under 35 USC § 119 of Korean Patent Application No. 10-2024-0167798 filed on Nov. 21, 2024 in the Korean Intellectual Property Office, the entire disclosure of which is incorporated herein by reference for all purposes.

### BACKGROUND

### 1. Field

Embodiments of the present disclosure relate to an apparatus and method for estimating a three-dimensional human pose.

### 2. Description of Related Art

The goal of three-dimensional human pose estimation is to estimate three-dimensional positions of human body joints from images. This task may be used in a variety of applications, including action recognition, human pose tracking, and human-computer interaction. Recently, with the development of deep convolutional neural networks, the performance of deep learning-based three-dimensional human pose estimation has improved. However, it still faces limitations in that reliable results can only be obtained within a limited laboratory environment.

Previous studies have mainly used two-dimensional data lacking depth information to predict three-dimensional poses, and have attempted to increase the diversity of training data by employing synthetic image generation or data augmentation techniques to enable models to adapt to various environments. However, despite numerous research efforts, estimating an accurate pose remains a challenging problem when the environmental background is complex or different from the learning environment. In particular, end body parts such as hands, feet, and elbows tend to be predicted with large errors. Incorrect detection of these end body parts causes serious problems in pose estimation.

Examples of related art may include Korean Unexamined Patent Application Publication No. 10-2023-0009676.

### SUMMARY

Embodiments of the present disclosure are intended to provide an apparatus and method for estimating a three-dimensional human pose capable of accurately estimating a human pose.

According to an embodiment of the present disclosure, there is provided an apparatus for estimating a three-dimensional human pose that includes one or more processors and a memory storing one or more programs executed by the one or more processors, the apparatus including a two-dimensional pose estimator configured to generate two-dimensional pose information about joint positions of a human body from an input two-dimensional image and a lifting network configured to convert the two-dimensional pose information into three-dimensional pose information.

The two-dimensional pose estimator may be fine-tuned based on a target data loss set based on a difference between two-dimensional target pose information input and two-dimensional diffusion pose information for two-dimensional target pose information generated through a diffusion network.

The two-dimensional diffusion pose information may be generated based on three-dimensional target pose information generated by inputting the two-dimensional target pose information into the lifting network.

The apparatus for estimating the three-dimensional human pose may be configured to generate three-dimensional target variation pose information by varying the three-dimensional target pose information, generate a two-dimensional diffusion image by projecting the three-dimensional target variation pose information into two dimensions and then inputting the projected three-dimensional target variation pose information into a diffusion network, and generate the two-dimensional diffusion pose information by inputting the two-dimensional diffusion image into the two-dimensional pose estimator.

The apparatus for estimating the three-dimensional human pose may be configured to generate the three-dimensional target variation pose information by adding noise to information about at least one of human body's hands, feet, elbows, and knees among the three-dimensional target pose information.

The lifting network may be trained based on a feedback loss set based on three-dimensional source input pose information, three-dimensional augmented input pose information, three-dimensional source variation pose information, and three-dimensional augmented variation pose information.

The three-dimensional augmented input pose information may be generated by augmenting the three-dimensional source input pose information, the three-dimensional source variation pose information may be generated by varying three-dimensional pose information which is an output of the lifting network for two-dimensional source pose information, and the three-dimensional augmented variation pose information may be generated by varying three-dimensional pose information which is an output of the lifting network for two-dimensional augmented pose information generated by augmenting the two-dimensional source pose information.

The lifting network part may be trained based on the target data loss in addition to the feedback loss.

The lifting network may be trained further based on a three-dimensional loss generated based on a difference between an output of the lifting network for the two-dimensional source pose information and the two-dimensional augmented pose information and the three-dimensional source input pose information and the three-dimensional augmented input pose information, in addition to the target data loss.

According to another embodiment of the present disclosure, there is provided a method of estimating a three-dimensional human pose performed on a computing device that includes one or more processors and a memory storing one or more programs executed by the one or more processors, the method including a two-dimensional pose estimation step of generating two-dimensional pose information about joint positions of a human body from an input two-dimensional image and a lifting step of converting the two-dimensional pose information into three-dimensional pose information using a lifting network.

The two-dimensional pose estimation step may include a step of fine-tuning based on a target data loss set based on a difference between two-dimensional target pose information input and two-dimensional diffusion pose information for two-dimensional target pose information generated through a diffusion network.

The lifting step may include a step of training the lifting network, and the lifting network may be trained based on a feedback loss set based on three-dimensional source input pose information, three-dimensional augmented input pose information, three-dimensional source variation pose information, and three-dimensional augmented variation pose information.

The three-dimensional augmented input pose information may be generated by augmenting the three-dimensional source input pose information, the three-dimensional source variation pose information may be generated by varying three-dimensional pose information which is an output of the lifting network for two-dimensional source pose information, and the three-dimensional augmented variation pose information may be generated by varying three-dimensional pose information which is an output of the lifting network for two-dimensional augmented pose information generated by augmenting the two-dimensional source pose information.

The lifting network may be trained further based on a three-dimensional loss generated based on a difference between an output of the lifting network for the two-dimensional source pose information and the two-dimensional augmented pose information and the three-dimensional source input pose information and the three-dimensional augmented input pose information, in addition to the target data loss.

### BRIEF DESCRIPTION OF THE DRAWINGS

FIG. 1 is a configuration diagram of an apparatus for estimating a three-dimensional human pose according to an embodiment.

FIG. 2 is an exemplary diagram for describing a learning method of an apparatus for estimating a three-dimensional human pose according to an embodiment.

FIG. 3 is a flowchart illustrating a method of estimating a three-dimensional human pose according to an embodiment.

FIG. 4 is a block diagram illustrating a computing environment including a computing device suitable for use in exemplary embodiments.

### DETAILED DESCRIPTION

Hereinafter, specific embodiments of the present disclosure will be described with reference to the drawings. The following detailed description is provided to facilitate a comprehensive understanding of the methods, apparatuses, and/or systems described herein. However, this is only an example and the present disclosure is not limited thereto.

In describing embodiments of the present disclosure, if it is determined that a specific description of a related known function of the preset invention may unnecessarily obscure the gist of the present disclosure, the detailed description thereof will be omitted. The terms described below are terms defined in consideration of the functions in the present disclosure, and vary depending on the intention or custom of the user or operator. Therefore, the definition should be made based on the contents throughout this specification. The terminology used in the detailed description is for the purpose of describing embodiments of the present disclosure only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

In addition, terms such as “first,” “second,” etc. may be used to describe various components, but the components should not be limited by the terms. The terms may be used to distinguish one component from another. For example, without departing from the scope of the present disclosure, a first component may be referred to as a second component, and similarly, a second component may also be referred to a first component.

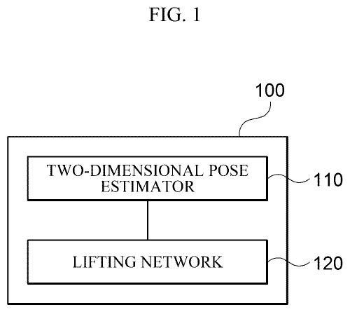

FIG. 1 is a configuration diagram of an apparatus for estimating a three-dimensional human pose according to an embodiment.

According to an embodiment, an apparatus for estimating a three-dimensional human pose may include a two-dimensional pose estimator 110 that generates two-dimensional pose information about joint positions of a human body from an input two-dimensional image and a lifting network 120 that converts the two-dimensional pose information into three-dimensional pose information.

The two-dimensional pose estimator 110 may predict two-dimensional key points representing joint positions of a person in the input image. The two-dimensional pose estimator 110 extracts (x, y) coordinates for each joint of the human body within the image, thereby providing basic data that a lifting network can convert data from two dimension to three dimension.

The lifting network 120 may receive a two-dimensional keypoint extracted from the two-dimensional pose estimator 110 as input and convert it into a three-dimensional keypoint. The lifting network 120 may estimate three-dimensional position of each joint by predicting depth information that cannot be obtained from only two-dimensional coordinates on the image. This process is done by extending the (x, y) coordinates of the two-dimensional keypoint into (x, y, z) coordinates in a three-dimensional space.

The lifting network 120 may utilize a feedback learning mechanism to adapt to a target domain. For example, the lifting network 120 may generate a group of various varied three-dimensional pose candidates and utilize them in a feedback loop to select an optimal three-dimensional pose. Through this, the lifting network 120 may perform reliable three-dimensional pose prediction in the target domain.

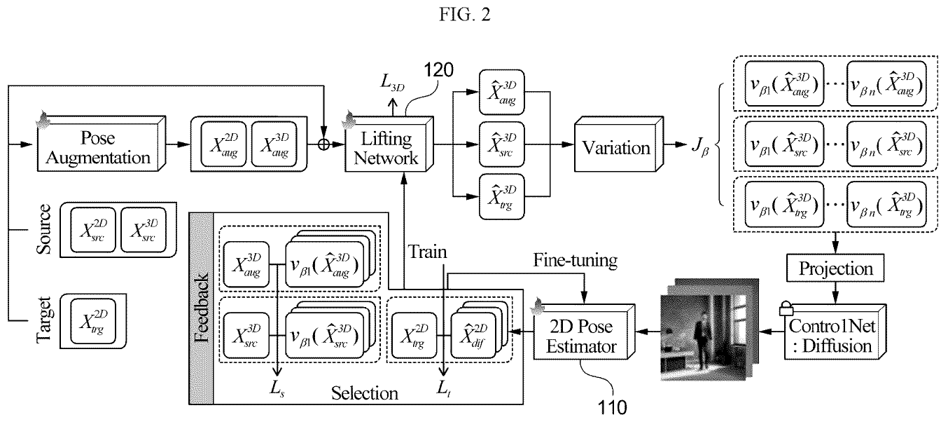

FIG. 2 is an exemplary diagram for describing a learning method of an apparatus for estimating a three-dimensional human pose according to an embodiment.

According to an embodiment, the two-dimensional pose estimator 110 may be fine-tuned based on target data loss generated based on input two-dimensional target pose information and two-dimensional diffusion pose information for the two-dimensional target pose information generated through diffusion.

Referring to FIG. 2, two-dimensional target pose information

$${X}_{trg}^{2 D} ,$$

two-dimensional source pose information

$${X}_{src}^{2 D} ,$$

and three-dimensional source input pose information

$${X}_{src}^{3 D}$$

may be input for learning of the apparatus for estimating the three-dimensional human pose.

According to an embodiment, two-dimensional diffusion pose information

$${\hat{X}}_{dif}^{2 D}$$

may be generated based on three-dimensional target pose information

$${\hat{X}}_{trg}^{3 D}$$

for two-dimensional target pose information

$${X}_{trg}^{2 D}$$

generated through the inputting network 120. Specifically, the two-dimensional diffusion pose information

$${\hat{X}}_{dif}^{2 D}$$

may be generated by inputting a two-dimensional diffusion image generated by projecting three-dimensional target variation pose information

$${𝒱}_{{β}_{1}} ( {\hat{X}}_{trg}^{3 D} ) … {𝒱}_{{β}_{n}} ( {\hat{X}}_{trg}^{3 D} ) ,$$

which is generated by varying the three-dimensional target pose information

$${\hat{X}}_{trg}^{3 D}$$

into two dimension and mien diffusion, into the two-dimensional pose estimator.

As an example, a pose augmentation may generate two-dimensional augmented pose information

$${X}_{aug}^{2 D}$$

and three-dimensional augmented pose information

$${X}_{aug}^{3 D}$$

by augmenting two-dimensional source pose information

$${X}_{src}^{2 D}$$

and three-dimensional source input pose information

$${X}_{src}^{3 D} .$$

In this case, the pose augmentation may augment the three-dimensional source input pose information

$${X}_{src}^{3 D}$$

by referring to the two-dimensional target pose information

$${X}_{trg}^{2 D} .$$

The lifting network 120 may receive two-dimensional target pose information

$${X}_{trg}^{2 D} ,$$

two-dimensional source pose information

$${X}_{src}^{2 D} ,$$

and two-dimensional augmented pose information

$${X}_{aug}^{2 D}$$

and generate three-dimensional pose information

$${\hat{X}}_{trg}^{3 D} , {\hat{X}}_{src}^{3 D} , and {\hat{X}}_{aug}^{3 D} ,$$

respectively. The lifting network 120 may be a neural network that receives two-dimensional pose information and predicts three-dimensional pose information. Since this lifting network is a well-known technology, a detailed description thereof will be omitted.

As an example, the apparatus for estimating the three-dimensional human pose 100 may generate three-dimensional variation pose information

$${𝒱}_{{β}_{1}} ( {\hat{X}}_{trg}^{3 D} ) … {𝒱}_{{β}_{n}} ( {\hat{X}}_{trg}^{3 D} ) ,$$

$${𝒱}_{{β}_{1}} ( {\hat{X}}_{src}^{3 D} ) … {𝒱}_{{β}_{n}} ( {\hat{X}}_{src}^{3 D} ) , and {𝒱}_{{β}_{1}} ( {\hat{X}}_{aug}^{3 D} ) … {𝒱}_{{β}_{n}} ( {\hat{X}}_{aug}^{3 D} )$$

by varying three-dimensional pose information

$${\hat{X}}_{trg}^{3 D} , {\hat{X}}_{src}^{3 D} , and {\hat{X}}_{aug}^{3 D} ,$$

respectively.

As an example, variation may be performed by adding noise to information about at least one of the human body's end body parts, i.e., the hands, feet, elbows, and knees, among the three-dimensional target pose information. For example, the apparatus for estimating the three-dimensional human pose 100 may generate a group of varied pose candidates by adding noise only to dynamic end body parts, such as hands, feet, elbows, etc. Specifically, the apparatus for estimating the three-dimensional human pose 100 may generate various varied poses V_{β} (i.e., three-dimensional variation pose information) by adding a randomly sampled noise value β to a three-dimensional pose prediction value \hat{X}^{3D} (i.e., three-dimensional pose information) of the lifting network 120. For example, the varied pose may be expressed as Equation 1 below.

$${𝒱}_{β n} ( {\hat{X}}_{k}^{3 D} ) = ( {\hat{x}}_{k}^{3 D} + {β}_{( n , k )}^{x} , {\hat{y}}_{k}^{3 D} + {β}_{( n , k )}^{y} , {\hat{z}}_{k}^{3 D} + {β}_{( n , k )}^{z} ) \qquad [ Equation 1 ]$$

Here, k represents a specific point (e.g., a hand or a foot), and βx, βy, and βz represent noise applied to each coordinate axis. Each Jβ below represents an updated list of keypoint candidates with different ranges of variation applied.

$${J}_{β} = [ {𝒱}_{β1} ( {\hat{X}}^{3 D} ) , {𝒱}_{β2} ( {\hat{X}}^{3 D} ) , … , {𝒱}_{β n} ( {\hat{X}}^{3 D} ) ] \qquad [ Equation 2 ]$$

Among the three-dimensional variation pose information generated in this way,

$${𝒱}_{{β}_{1}} ( {\hat{X}}_{trg}^{3 D} ) … {𝒱}_{{β}_{n}} ( {\hat{X}}_{trg}^{3 D} )$$

(i.e., three-dimensional target variation pose information) for two-dimensional target pose information

$${X}_{trg}^{2 D}$$

may be converted into two-dimensional data (e.g., two-dimensional pose map) through projection and respectively input into a diffusion network.

For example, a projected keypoint value

$${\hat{X}}_{proj}^{2 D} of {\hat{X}}_{trg}^{3 D}$$

may be generated as in Equation 3 through a projection function f.

$${\hat{X}}_{proj}^{2 D} = f ( {\hat{X}}_{trg}^{3 D} ) \qquad [ Equation 3 ]$$

In addition, after generating a two-dimensional pose map using the projected

$${\hat{X}}_{proj}^{2 D} ,$$

the two-dimensional pose map may be input into the diffusion network.

As an example, the diffusion network may generate a two-dimensional diffusion image from two-dimensional data for the projected target (i.e., the two-dimensional pose map), and the two-dimensional diffusion image generated through the diffusion network may be input to the two-dimensional pose estimator 110. The diffusion network may generate a two-dimensional image I_{D} using Equation 4 below.

$${I}_{D} = D ( {\hat{X}}_{proj}^{2 D} ) \qquad [ Equation 4 ]$$

The two-dimensional pose estimator 110 may generate two-dimensional diffusion pose information

$${\hat{X}}_{dif}^{2 D}$$

for two-dimensional target pose information

$${X}_{trg}^{2 D}$$

from the two-dimensional diffusion image output from the diffusion network. Here, the diffusion network may be a pre-trained neural network that generates the two-dimensional diffusion image from the two-dimensional pose map, which is two-dimensional data. In this case, the diffusion network may additionally receive a prompt about the background of the target domain (i.e., a prompt to match the background of the two-dimensional diffusion image to be generated to the target domain).

When the two-dimensional diffusion pose information

$${\hat{X}}_{dif}^{2 D}$$

is generated, the two-dimensional pose estimator 110 may be fine-tuned by a target data loss set based on the two-dimensional target pose information

$${X}_{trg}^{2 D}$$

and the two-dimensional diffusion pose information

$${\hat{X}}_{dif}^{2 D} .$$

For example, the target data loss may be obtained by calculating the mean square error (MSE) of the two-dimensional target pose information

$${X}_{trg}^{2 D}$$

and the two-dimensional diffusion pose information

$${\hat{X}}_{dif}^{2 D}$$

as follows.

$${ℒ}_{t} = {w}_{2 d} {‖ {\hat{X}}_{dif}^{2 D} - {X}_{trg}^{2 D} ‖}_{2} \qquad [ Equation 5 ]$$

Here, w_{2d} is a parameter that controls a weight of the error.

According to an embodiment, the lifting network 120 may be trained based on a feedback loss. Here, the feedback loss may be set based on the three-dimensional source input pose information

$${X}_{src}^{3 D} ,$$

the three-dimensional augmented input pos information

$${X}_{aug}^{3 D} ,$$

the three-dimensional source variation pose information

$${V}_{{β}_{1}} ( {\hat{X}}_{src}^{3 D} ) … {V}_{{β}_{n}} ( {\hat{X}}_{src}^{3 D} ) ,$$

and the three-dimensional augmented variation pose information

$${V}_{{β}_{1}} ( {\hat{X}}_{aug}^{3 D} ) … {V}_{{β}_{n}} ( {\hat{X}}_{aug}^{3 D} ) .$$

According to an embodiment, the three-dimensional source variation pose information

$${V}_{{β}_{1}} ( {\hat{X}}_{src}^{3 D} ) … {V}_{{β}_{n}} ( {\hat{X}}_{src}^{3 D} )$$

and the three-dimensional augmented variation pose information

$${V}_{{β}_{1}} ( {\hat{X}}_{aug}^{3 D} ) … {V}_{{β}_{n}} ( {\hat{X}}_{aug}^{3 D} )$$

may be generated by varying the output of the lifting network 120 for the two-dimensional source pose information

$${X}_{src}^{2 D}$$

and the two-dimensional augmented pose information

$${X}_{aug}^{2 D} ,$$

respectively.

The feedback loss may be computed through the MSE between X_{3D} and V_{β} (\hat{X}^{3D}) for the source data and the augmented data. That is, the feedback loss may be computed through the MSE between the three-dimensional source input pose information

$${X}_{src}^{3 D}$$

and the three-dimensional source transformation pose information

$${v}_{{β}_{1}} ( {\hat{X}}_{src}^{3 D} ) … {v}_{{β}_{n}} ( {\hat{X}}_{src}^{3 D} )$$

and the MSE between the three-dimensional augmented input pose information

$${X}_{aug}^{3 D}$$

and the three-dimensional augmented transformation pose information

$${v}_{{β}_{1}} ( {\hat{X}}_{aug}^{3 D} ) … {v}_{{β}_{n}} ( {\hat{X}}_{aug}^{3 D} ) .$$

Finally, the

$${v}_{β} ( {\hat{X}}_{src}^{3 D} )$$

with the minimum MSE among the three-dimensional source variation pose information

$${v}_{{β}_{1}} ( {\hat{X}}_{src}^{3 D} ) … {v}_{{β}_{n}} ( {\hat{X}}_{src}^{3 D} )$$

may be selected as a final prediction value, and the

$${v}_{β} ( {\hat{X}}_{aug}^{3 D} )$$

with the minimum MISE among the three-dimensional augmented variation pose information

$${v}_{{β}_{1}} ( {\hat{X}}_{aug}^{3 D} ) … {v}_{{β}_{n}} ( {\hat{X}}_{aug}^{3 D} )$$

may be selected as the final prediction value. The feedback loss may be defined as in Equation 6 below.

$${ℒ}_{s} = {‖ {X}^{3 D} - {𝒱}_{β} ( {\hat{X}}^{3 D} ) ‖}_{2} \qquad [ Equation 6 ]$$

According to an embodiment, the lifting network 120 may be trained further based on the target data loss. For example, the loss function of the lifting network 120 may be defined as follows.

$${ℒ}_{f} = \{ \begin{matrix}{ℒ}_{t} , & if data is target dataset \\ {ℒ}_{s} , & otherwise\end{matrix} \qquad [ Equation 7 ]$$

According to an embodiment, the lifting network 120 may be trained further based on a three-dimensional loss generated based on a difference between the output of the lifting network for the two-dimensional source pose information

$${X}_{src}^{2 D}$$

and the two-dimensional augmented pose information

$${X}_{aug}^{2 D}$$

and the three-dimensional source input pose information

$${X}_{src}^{3 D}$$

and the three-dimensional augmented input pose information

$${X}_{aug}^{3 D} .$$

The lifting network 120 may compute the three-dimensional loss as follows using a three-dimensional correct value and a predicted three-dimensional value of the source data set and augmented data set.

$${ℒ}_{3 D} = {‖ {X}^{3 D} - {\hat{X}}^{3 D} ‖}_{2} \qquad [ Equation 8 ]$$

Finally, the total loss of the lifting network 120 may be computed by integrating mathematical expressions 7 and 8. For example, the final loss may be computed Equation 9 below.

$${ℒ}_{total} = {w}_{3 d} {ℒ}_{3 D} + {w}_{f} {ℒ}_{f} \qquad [ Equation 9 ]$$

Here, w_{3d} and w_{f} are given weights.

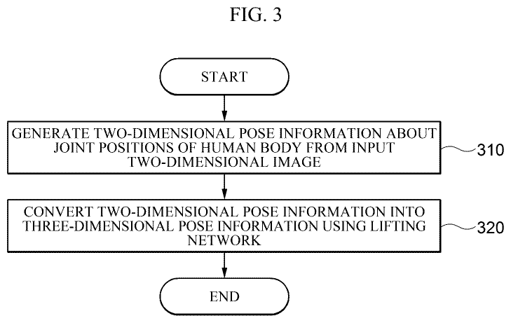

FIG. 3 is a flowchart illustrating a method of estimating a three-dimensional human pose according to an embodiment.

According to an embodiment, the apparatus for estimating the three-dimensional human pose may be a computing device including one or more processors and a memory storing one or more programs executed by the one or more processors.

According to an embodiment, the apparatus for estimating the three-dimensional human pose may generate two-dimensional pose information about joint positions of a human body from an input two-dimensional image (310), and may convert the two-dimensional pose information into three-dimensional pose information using a lifting network (320).

In the description of the embodiment of FIG. 3, descriptions of the embodiment that overlap with the contents described with reference to FIGS. 1 and 2 are omitted.

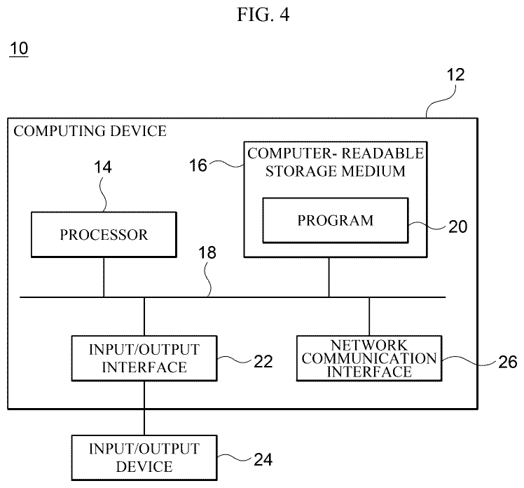

FIG. 4 is a block diagram illustrating a computing environment 10 including a computing device suitable for use in exemplary embodiments. In the illustrated embodiment, respective components may have different functions and capabilities other than those described below, and include additional components in addition to those described below.

The illustrated computing environment 10 includes a computing device 12. In an embodiment, the computing device 12 may be the apparatus for estimating a three-dimensional human pose.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to an aspect, domain adaptation capabilities for the target domain are enhanced, thereby capable of increasing the accuracy of three-dimensional pose prediction even in complex backgrounds and noisy environments.

In particular, prediction errors in end body parts can be reduced and robust three-dimensional pose estimation can be performed in various environments through diffusion model-based feedback learning.

Although representative embodiments of the present disclosure have been described in detail above, those skilled in the art will understand that various modifications may be made to the above-described embodiments without departing from the scope of the present disclosure. Therefore, the scope of the present disclosure should not be limited to the described embodiments, but should be defined not only by the patent claims described below but also by those equivalent to the patent claims.

What is claimed is:

1. An apparatus for estimating a three-dimensional human pose, the apparatus including one or more processors and a memory storing one or more programs executed by the one or more processors, the apparatus comprising:
a two-dimensional pose estimator configured to generate two-dimensional pose information about joint positions of a human body from an input two-dimensional image; and
a lifting network configured to convert the two-dimensional pose information into three-dimensional pose information.

2. The apparatus of claim 1, wherein the two-dimensional pose estimator is fine-tuned based on a target data loss set based on a difference between two-dimensional target pose information input and two-dimensional diffusion pose information for two-dimensional target pose information generated through a diffusion network.

3. The apparatus of claim 2, wherein the two-dimensional diffusion pose information is generated based on three-dimensional target pose information generated by inputting the two-dimensional target pose information into the lifting network.

4. The apparatus of claim 3, wherein the apparatus for estimating the three-dimensional human pose is configured to generate three-dimensional target variation pose information by varying the three-dimensional target pose information, generate a two-dimensional diffusion image by projecting the three-dimensional target variation pose information into two dimensions and then inputting the projected three-dimensional target variation pose information into a diffusion network, and generate the two-dimensional diffusion pose information by inputting the two-dimensional diffusion image into the two-dimensional pose estimator.

5. The apparatus of claim 4, wherein the apparatus for estimating the three-dimensional human pose is configured to generate the three-dimensional target variation pose information by adding noise to information about at least one of human body's hands, feet, elbows, and knees among the three-dimensional target pose information.

6. The apparatus of claim 2, wherein the lifting network is trained based on a feedback loss set based on three-dimensional source input pose information, three-dimensional augmented input pose information, three-dimensional source variation pose information, and three-dimensional augmented variation pose information.

7. The apparatus of claim 6, wherein the three-dimensional augmented input pose information is generated by augmenting the three-dimensional source input pose information,
the three-dimensional source variation pose information is generated by varying three-dimensional pose information which is an output of the lifting network for two-dimensional source pose information, and
the three-dimensional augmented variation pose information is generated by varying three-dimensional pose information which is an output of the lifting network for two-dimensional augmented pose information generated by augmenting the two-dimensional source pose information.

8. The apparatus of claim 7, wherein the lifting network part is trained based on the target data loss in addition to the feedback loss.

9. The apparatus of claim 8, wherein the lifting network is trained further based on a three-dimensional loss generated based on a difference between an output of the lifting network for the two-dimensional source pose information and the two-dimensional augmented pose information and the three-dimensional source input pose information and the three-dimensional augmented input pose information, in addition to the target data loss.

10. A method of estimating a three-dimensional human pose performed on a computing device that includes one or more processors and a memory storing one or more programs executed by the one or more processors, the method comprising:
a two-dimensional pose estimation step of generating two-dimensional pose information about joint positions of a human body from an input two-dimensional image; and
a lifting step of converting the two-dimensional pose information into three-dimensional pose information using a lifting network.

11. The method of claim 10, wherein the two-dimensional pose estimation step includes a step of fine-tuning based on a target data loss set based on a difference between two-dimensional target pose information input and two-dimensional diffusion pose information for two-dimensional target pose information generated through a diffusion network.

12. The method of claim 11, wherein the lifting step includes a step of training the lifting network, and
the lifting network is trained based on a feedback loss set based on three-dimensional source input pose information, three-dimensional augmented input pose information, three-dimensional source variation pose information, and three-dimensional augmented variation pose information.

13. The method of claim 12, wherein the three-dimensional augmented input pose information is generated by augmenting the three-dimensional source input pose information,
the three-dimensional source variation pose information is generated by varying three-dimensional pose information which is an output of the lifting network for two-dimensional source pose information, and
the three-dimensional augmented variation pose information is generated by varying three-dimensional pose information which is an output of the lifting network for two-dimensional augmented pose information generated by augmenting the two-dimensional source pose information.

14. The method of claim 13, wherein the lifting network is trained further based on a three-dimensional loss generated based on a difference between an output of the lifting network for the two-dimensional source pose information and the two-dimensional augmented pose information and the three-dimensional source input pose information and the three-dimensional augmented input pose information, in addition to the target data loss.

15. A computer program stored on a non-transitory computer readable storage medium, the computer program including one or more instructions, the one or more instructions, when executed by a computing device having one or more processors, causing the computing device to perform:
a two-dimensional pose estimation step of generating two-dimensional pose information about joint positions of a human body from an input two-dimensional image; and
a lifting step of converting the two-dimensional pose information into three-dimensional pose information using a lifting network.
